(19) United States
(12) Patent Application Publication
(10) Pub. No.: US 2025/0045859 A1
(43) Pub. Date: Feb. 6, 2025

(54) INFORMATION MANAGEMENT SYSTEM, INFORMATION MANAGEMENT APPARATUS, INFORMATION MANAGEMENT METHOD, AND NON-TRANSITORY COMPUTER-READABLE STORAGE MEDIUM

(71) Applicant: NEC Corporation, Minato-ku, Tokyo (JP)

(72) Inventor: Tomoki INOUE, Tokyo (JP)

(73) Assignee: NEC Corporation, Minato-ku, Tokyo (JP)

(21) Appl. No.: 18/718,550

(22) PCT Filed: Dec. 27, 2021
(86) PCT No.: PCT/JP2021/048590

§ 371 Date: Jun. 11, 2024

(51) Int. Cl. G06Q 50/40; G07B 15/02

(52) U.S. Cl. CPC G06Q 50/40; G07B 15/02

(57) ABSTRACT

An information management apparatus (100) includes: an issuing unit (102) that issues at least one token for each moving body; an allocation unit (104) that allocates, when detecting that a passenger boards the moving body, the token for the moving body to the passenger, a release unit (106) that releases, when detecting that the passenger alights from the moving body, allocation of the token to the passenger; and a determination unit (108) that determines, by using token history information indicating a history of allocation and release of the token, a boarding history for the moving body of the passenger.

### TECHNICAL FIELD

The present invention relates to an information management system, an information management apparatus, an information management method, and a program, and particularly, relates to an information management system, an information management apparatus, an information management method, and a program that manage a token issued for each moving body.

### BACKGROUND ART

In recent years, usage of a digital ticket service is prevailing in various scenes. Patent Document 1 describes a system that packages, into one package, digital tickets relating to services provided from different providers and provides the package for a user.

Patent Document 2 describes a system that issues, as a token, transaction information of usage of a transportation facility or facility, writes information in a block chain, and causes a mobile terminal of a user to display the transaction information.

### RELATED DOCUMENTS

### Patent Documents

Patent Document 1: Japanese Patent Application Publication No. 2021-149846
Patent Document 2: Japanese Patent Application Publication No. 2021-117707

### SUMMARY OF INVENTION

### Technical Problem

In the techniques described in the patent documents, a ticket for using a public transportation facility and the like is digitalized, a token is issued and registered in a mobile terminal of a user, and thereby the token can be used. However, in the both documents, a boarding ticket, or a ticket for a reserved seat or facility usage is merely issued. In the both documents, there is no idea that a physical space of a moving body is recognized as an asset, a token is assigned to the space, and the token is issued to a user.

In recent years, as a countermeasure against an infectious disease and the like, congestion reduction of a public transportation facility in a commuting time and the like is an urgent issue. Also in order to solve the issue, it is desirable that a current situation of boarding/alighting of a passenger to/from a moving body can be recognized and managed.

In view of the circumstances, the present invention has been made, and an object of the present invention is to provide a technique for efficiently managing a boarding/alighting situation of a passenger in a moving body.

### Solution to Problem

According to each aspect of the present invention, in order to solve the above-described issues, the following configuration is employed for each aspect.

A first aspect relates to an information management apparatus.

The information management apparatus according to the first aspect includes:
an issuing unit that issues at least one token for each moving body;
an allocation unit that allocates, when detecting that a passenger boards the moving body, the token for the moving body to the passenger;
a release unit that releases, when detecting that the passenger alights from the moving body, allocation of the token to the passenger; and
a determination unit that determines, by using token history information indicating a history of allocation and release of the token, a boarding history for the moving body of the passenger.

A second aspect relates to an information management method executed by at least one computer.

The information management method according to the second aspect includes,
by an information management apparatus:
issuing at least one token for each moving body;
allocating, when detecting that a passenger boards the moving body, the token for the moving body to the passenger;
releasing, when detecting that the passenger alights from the moving body, allocation of the token to the passenger; and
determining, by using token history information indicating a history of allocation and release of the token, a boarding history for the moving body of the passenger.

Note that, another aspect of the present invention may be a program causing at least one computer to execute the method according to the second aspect, and may be a computer-readable storage medium storing such a program. The storage medium includes a non-transitory and tangible medium.

The computer program includes, when executed by a computer, a computer program code causing the computer to execute the information management method.

Note that, any combination of the above-described components and an expression in which the expression of the present invention is converted among a method, an apparatus, a system, a storage medium, a computer program, and the like is also effective as an aspect of the present invention.

Further, various types of components according to the present invention do not necessarily need to be present individually and independently, and a plurality of components may be formed as one member, one component may be formed with a plurality of members, a certain component may be a part of another component, a part of a certain component and a part of another component are overlapped with each other, and such another case may be employed.

Further, while in the method and the computer program according to the present invention, a plurality of procedures are described in order, the described order does not limit an order for executing a plurality of procedures. Therefore, when the method and the computer program according to the present invention are executed, an order of the plurality of procedures can be modified within an extent that there is no harm in context.

Further, a plurality of procedures of the method and the computer program according to the present invention are executed at timing different individually without limitation. Therefore, during execution of a certain procedure, another procedure may occur, execution timing of a certain procedure and execution timing of another procedure may be overlapped partially or entirely, or such another case may occur.

### Advantageous Effects of Invention

According to each of the aspects, a technique for efficiently managing a boarding/alighting situation of a passenger in a moving body can be provided.

### BRIEF DESCRIPTION OF THE DRAWINGS

FIG. 1 It is a diagram illustrating an information management system according to an example embodiment of the present invention.

FIG. 2 It is a block diagram illustrating a hardware configuration of each computer configuring the information management system.

FIG. 3 It is a function block diagram logically illustrating a configuration of an information management apparatus according to an example embodiment.

FIG. 4 It is a diagram schematically illustrating a plurality of tokens to be issued.

FIG. 5 It is a diagram illustrating one example of data structure of a token.

FIG. 6 It is a diagram illustrating a scene in which a token is recorded.

FIG. 7 It is a flowchart illustrating an operation example of the information management system according to the example embodiment.

FIG. 8 It is a diagram illustrating one example of data structure of a token according to the example embodiment.

FIG. 9 It is a function block diagram logically illustrating a configuration of an information management apparatus according to the example embodiment.

FIG. 10 It is a diagram illustrating an example of an applied fare for each time period.

FIG. 11 It is a flowchart illustrating an operation example of settlement processing of the information management apparatus according to the example embodiment.

### EXAMPLE EMBODIMENT

Hereinafter, example embodiments according to the present invention are described by using the accompanying drawings. Note that in all drawings, a similar component is assigned with a similar reference sign, and description thereof is not included as appropriate. Further, in the following figures, a configuration of a portion not relating to the essence of the present invention is not included, and therefore, is not illustrated.

According to the example embodiments, “acquisition” includes at least one of a matter that a local apparatus fetches data or information stored in another apparatus or a storage medium (active acquisition), and a matter that data or information output from another apparatus is input to a local apparatus (passive acquisition). Examples of the active acquisition include a matter that reception is executed by making a request or an inquiry to another apparatus, a matter that reading is executed by accessing another apparatus or a storage medium, and the like. Further, examples of the passive acquisition include a matter that information distributed (or transmitted, notified on a push basis, or the like) is received, and the like. Furthermore, “acquisition” may be a matter that selective acquisition is executed from among received pieces of data or information, or a matter that distributed data or information is selectively received.

### First Example Embodiment

### <System Overview>

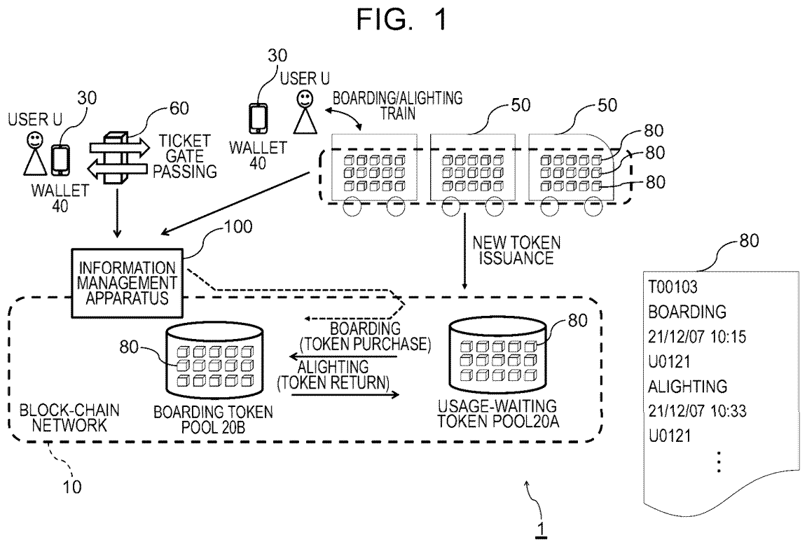

FIG. 1 is a diagram illustrating an information management system 1 according to an example embodiment of the present invention.

The information management system 1 manages, by using a token 80, information of boarding/alighting of a passenger to/from a moving body. In the example in FIG. 1, a boarding history for a railroad of a passenger is managed. The information management system 1 includes a plurality of nodes 20 (20A and 20B in FIG. 1) on a block-chain network 10, and an information management apparatus 100 that manages the plurality of nodes 20.

At least one token 80 is issued to a moving body. In an example of a railroad, a plurality of tokens 80 are issued to each car of a train. When, for example, a capacity of persons is determined for each car, the number of tokens 80 issued may be set, as an upper limit, a number relevant to the capacity: When a passenger boards a train, one token 80 is allocated to the passenger. The token 80 is not a so-called electronic ticket, but allocates a space of a car to the passenger. When the token 80 is allocated to the passenger, a space in the car relevant to the token 80 is allocated to the passenger.

The information management system 1 stores, in the token 80, in the node 20, and manages information relating to boarding/alighting to/from a moving body of a passenger.

A user U being a passenger previously installs, for example, in a user terminal 30, an application (hereinafter, also referred to as a “wallet 40”) in which an electronic payment means used for paying a fare of a railroad is registered, and previously registers the electronic payment means in such a way as to be usable.

Then, the user U previously selects, when using a railroad, the electronic payment means to be used for paying a fare on the wallet 40 of the user terminal 30, and makes entry by holding the user terminal 30 over an automatic ticket gate 60. When the entry of the user U is detected, a token 80 is allocated to the user U, and the token 80 is registered, for example, in the wallet 40.

The token 80 is, for example, a non-fungible token (NFT).

An entry record of a user U is transmitted to the information management apparatus 100, and recorded in the token 80 stored in the node 20 on the block-chain network 10. The block-chain network 10 includes a plurality of nodes 20.

Boarding to a moving body of a passenger can be detected, for example, based on an entry record for the automatic ticket gate 60. Further, alighting from a moving body of a passenger can be detected, for example, based on an exit record for the automatic ticket gate 60. In this manner, the information management apparatus 100 can acquire, from the automatic ticket gate 60, information indicating boarding/alighting of a passenger. Further, as another method, the information management apparatus 100 may acquire the information from usage information of an electronic payment means used for paying a fare on the wallet 40. Alternatively, a sensor is installed in a car 50, and boarding/alighting to/from the car 50 of a passenger may be detected. Details are described according to a second example embodiment to be described later.

As illustrated in FIG. 1, a plurality of tokens 80 issued are stored, for example, in a usage-waiting token pool 20A prior to allocation to a passenger. When boarding of a user U is detected, for example, a token 80 is registered in the wallet 40 of the user terminal 30 of the user U (illustrated as “token purchase” in the figure), and also the token 80 allocated to the user U moves to a boarding token pool 20B. Then, when alighting of the user U is detected, the token 80 allocated to the user U is returned from the boarding token pool 20B to the usage-waiting token pool 20A, and also the token 80 registered in the wallet 40 of the user terminal 30 of the user U is deleted (illustrated as “token return” in the figure).

However, FIG. 1 schematically illustrates allocation and release of a token 80 by being replaced with a concept of movement of the token 80, and therefore the token 80 does not actually move between the usage-waiting token pool 20A and the boarding token pool 20B. Actually, usage information (information indicating boarding/alighting) of each token 80 is recorded every time in the node 20 of the block-chain network 10. For each token 80, information indicating a user U allocated with the token 80 and information of a date and time in which the token 80 is allocated to the user U are recorded.

### <Hardware Configuration Example>

A plurality of nodes 20 and the information management apparatus 100 configuring the information management system 1 each are achieved by at least one computer. Further, the user terminal 30 of a user U is a smartphone, a tablet terminal, a wearable terminal, or the like, and these are also achieved by a computer.

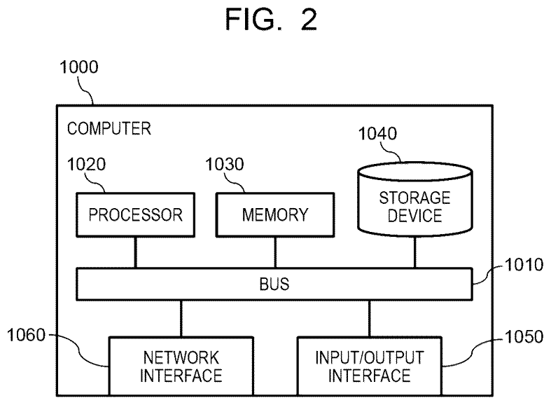

FIG. 2 is a block diagram illustrating a hardware configuration of each computer 1000 configuring the information management system 1 illustrated in FIG. 1.

The computer 1000 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

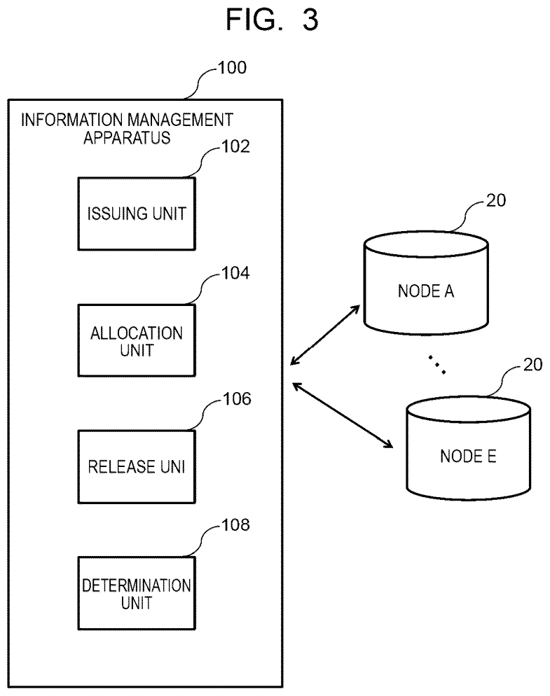

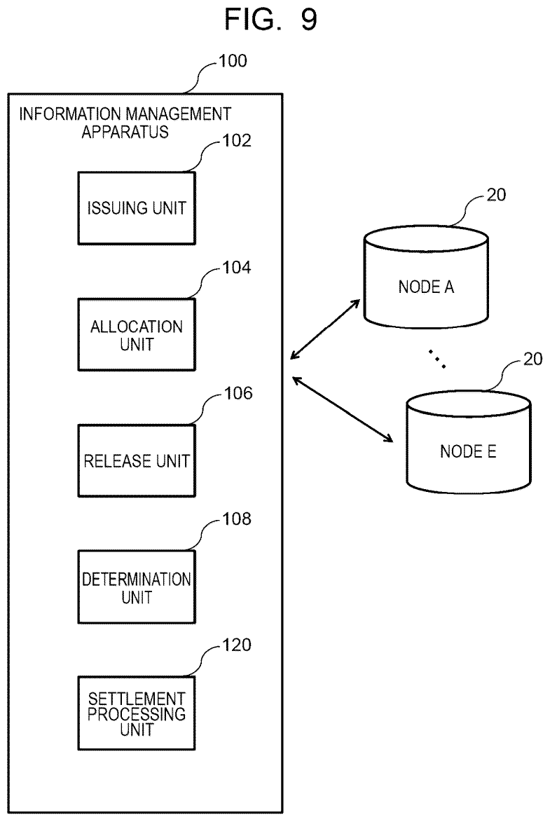

The storage device 1040 is an auxiliary storage apparatus achieved by a hard disk drive (HDD), a solid state drive (SSD), a memory card, a read only memory (ROM), or the like. The storage device 1040 stores a program module achieving each function (e.g., an issuing unit 102, an allocation unit 104, a release unit 106, and a determination unit 108 in FIG. 3 described later, a settlement processing unit 120 in FIG. 9, and the like) of the information management apparatus 100 of the information management system 1. The processor 1020 reads each of the program modules onto the memory 1030 and executes the read program module, and thereby achieves each function relevant to the program module. Further, the storage device 1040 also functions as a storage means (not illustrated) that stores various types of information used by the information management apparatus 100. Further a storage means of the node 20 may also be achieved by the storage device 1040.

A program module may be stored in a storage medium. The storage medium storing the program module includes a non-transitory and tangible medium usable by the computer 1000, and the computer 1000 (processor 1020)-readable program code may be embedded in the medium.

The input/output interface 1050 is an interface for connecting the computer 1000 and various types of input/output devices.

The network interface 1060 is an interface for connecting the computer 1000 to a communication network. The communication network is, for example, a local area network (LAN) and a wide area network (WAN). A method for connection of the network interface 1060 to the communication network may be wireless connection, or may be wired connection. However, the network interface 1060 may not necessarily used.

Then, the computer 1000 is connected, via the input/output interface 1050 or the network interface 1060, to a required device (e.g., the automatic ticket gate 60, various types of sensors (not illustrated) mounted on a moving body, and the like).

The information management system 1 may be achieved by a plurality of the computers 1000 configuring the information management apparatus 100 and the node 20.

Each component of the information management apparatus 100 according to the present example embodiment in FIG. 3 to be descried later is achieved by any combination of hardware of the computer 1000 in FIG. 2 and software. It should be understood to those of ordinary skill in the art that there are various modification examples for the achievement method and apparatus. A function block diagram illustrating the information management apparatus 100 according to each example embodiment does not indicate a configuration based on a hardware unit but indicate a block based on a logical function unit.

### <Function Configuration Example>

FIG. 3 is a function block diagram logically illustrating a configuration of the information management apparatus 100 according to the present example embodiment.

The information management apparatus 100 includes the issuing unit 102, the allocation unit 104, the release unit 106, and the determination unit 108.

The issuing unit 102 issues at least one token 80 for each moving body.

The allocation unit 104 allocates, when detecting that a passenger boards the moving body, the token 80 for the moving body to the passenger.

The release unit 106 releases, when detecting that the passenger alights from the moving body; the allocation of the token to the passenger.

The determination unit 108 determines, by using token history information indicating a history of allocation and release of the token 80, a boarding history for the moving body of the passenger.

The moving body includes a vehicle of a public transportation facility such as a railroad, a streetcar (track), a bus, a taxi, an aircraft, and a ship. The moving body may be a dish, a vehicle of an amusement park, or the like. Further, the moving body may be a vehicle such as a rental car and a rental bike. In other words, the moving body is not specifically limited to any moving body, as long as that the moving body has a space temporarily occupied by a passenger who pays a fee for the space and carries the passenger on board. According to the present example embodiment, the moving body is described by considering a railroad as an example.

At least one token 80 is issued for each moving body. For example, for a taxi, a rental bike, and the like, one token 80 may be issued to one moving body. For a railroad, a streetcar, a bus, an aircraft, a ship, and the like, a plurality of tokens 80 are issued to one moving body.

The moving body may include a plurality of cars. This matter is exemplified, for example, in a railroad and the like.

The issuing unit 102 may issue a plurality of tokens 80 for each car. The number of tokens 80 issued may have, as an upper limit. a number relevant to a capacity of the car. The number of tokens 80 issued may be changed according to a car even in the same train. Alternatively, the number of tokens 80 issued may be changed according to a time period. The number of issues may be previously set, or may not necessarily be set. The issuing unit 102 may issue a predetermined number of tokens 80 each time. The issuing unit 102 may additionally issue, when, for example, all issued tokens 80 are allocated, a predetermined number of tokens 80.

The information management apparatus 100 may include a reception unit (not illustrated) that receives setting of the number of tokens 80 issued. The reception unit receives specification of a unit (for each train, for each car, for each time period, or the like) of issuance and the number of issues.

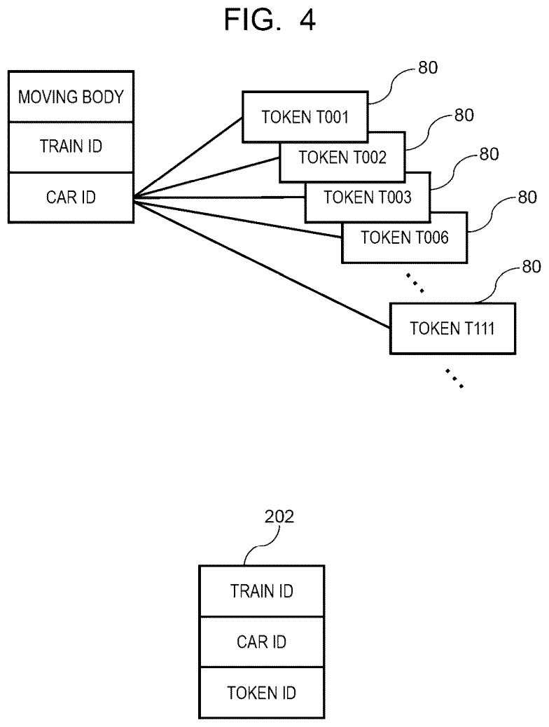

FIG. 4 is a diagram schematically illustrating a plurality of tokens 80 to be issued to one car.

For example, in a railroad, a plurality of tokens 80 are issued for each train and for each car. The token 80 may be provided with, for example, identification information (hereinafter, also referred to as a “token ID”). The issuing unit 102 stores, as issued-token information 202, a token ID of an issued token 80 in association with each train or each car in the storage device 1040, and manages the stored token 80. The issued-token information 202 stores, for example, a train ID, a car ID, and the token ID in association with one other. In other words, the determination unit 108 can determine, from the token ID, a train or a car allocated with the token 80.

The number of tokens 80 issued to a moving body is preferably a number equal to or larger than the number of persons assumed to board the moving body. Further, when all tokens 80 issued to a moving body are allocated to passengers, the issuing unit 102 may additionally issue a token 80 for the moving body.

As the number of tokens 80 allocated to passengers is increased, the number of passengers being on board the moving body is larger. In other words, the moving body is likely to be congested. In contrast, as the number of tokens 80 unallocated to passengers is increased, the number of passengers being on board the moving body is smaller. In other words, the moving body is likely to be uncrowded.

A user U previously selects, when using a railroad, an electronic payment means used for paying a fare on the wallet 40 of the user terminal 30, and makes entry by holding the user terminal 30 over the automatic ticket gate 60. The automatic ticket gate 60 may acquire, from the user terminal 30, identification information of the user U making entry.

The identification information of the user U may be, for example, user identification information in usage registration of the wallet 40 or may be user identification information in usage registration of an electronic payment means without specific limitation. However, it is assumed that acquisition of identification information of the user U is previously approved by the user U.

At that time, the allocation unit 104 records, in the token 80, identification information of the user U acquired by the issuing unit 102 from the automatic ticket gate 60 or a user ID provided for each acquired identification information of the user U. The record in the token 80 is stored in any node 20 on the block-chain network 10.

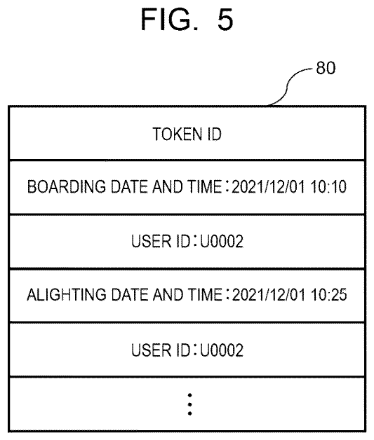

FIG. 5 is a diagram illustrating one example of data structure of the token 80.

The token 80 includes the token ID, information indicating a date and time in which boarding is detected, identification information of a user U making boarding, information indicating a date and time in which alighting is detected, and identification information of the user U making alighting. When the token 80 moves from the usage-waiting token pool 20A to the boarding token pool 20B in FIG. 1, a boarding date and time and a user ID are recorded in the token 80, and when the token 80 moves from the boarding token pool 20B to the usage-waiting token pool 20A, an alighting date and time and the user ID are recorded in the token 80.

In other words, at a time of boarding of the user U to a moving body, when the token 80 is allocated to the user U by the allocation unit 104, the user ID of the user and the boarding date and time are recorded in the token 80. Further, when the user U alights, the alighting date and time and the user ID are recorded in the token 80, and the allocation of the token 80 to the user U is released by the release unit 106.

In a case of a state where only the user ID and the boarding date and time are recorded in the token 80, it can be determined that the user U is being on board a moving body and alighting is not detected yet.

The token 80 can be allocated, after returned, to another user U using the moving body. When a next user U boards the moving body and then the token 80 is allocated to the next user U by the allocation unit 104, the user ID of the user and the boarding date and time are recorded in the token 80. Further, when the user U alights, the alighting date and time and the user ID are recorded in the token 80 by the release unit 106.

In this manner, in the token 80, records of boarding/alighting of a plurality of user U are accumulated.

In other words, the determination unit 108 can determine a boarding history for a moving body of a passenger, by using token history information associated with a past boarding history of the token 80 token.

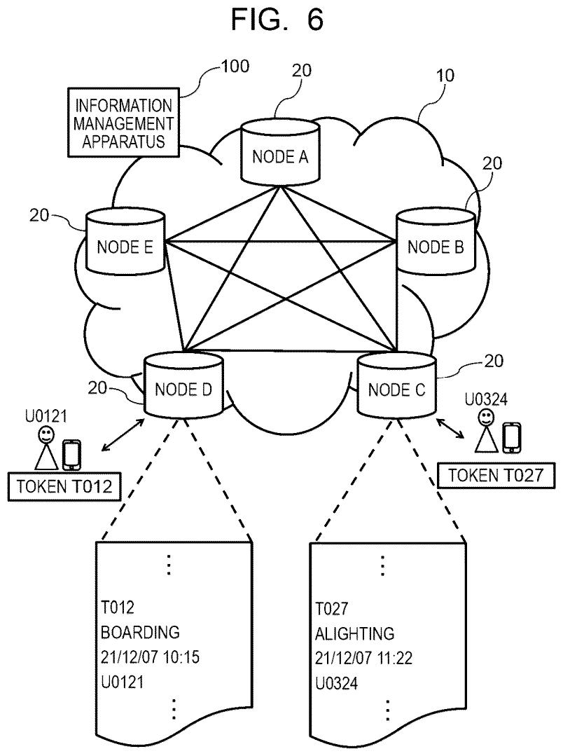

FIG. 6 illustrates a scene in which information of the token 80 allocated to each user U is recorded in a plurality of nodes 20.

As described above, in each node 20 of the block-chain network 10, a token ID of the token 80 allocated to a passenger, a boarding date and time or an alighting date and time, and a user ID are recorded every time and accumulated. A record of boarding and a record of alighting of a certain passenger may be recorded in different nodes 20 separately. Records of allocation and release of the token 80, i.e., records of boarding and alighting of a passenger recorded in a plurality of nodes 20 dispersedly are integrally managed by the information management apparatus 100. Therefore, the determination unit 108 can determine a usage history of each token 80 or a history of boarding/alighting of each passenger.

According to the present example embodiment, a history of the token 80 can be recorded on the block-chain network 10, and therefore, even information of different transportation facilities, for example, such as a railroad and an aircraft can be collectively managed by the information management system 1 when a mechanism of the information management system 1 is introduced. For example, a boarding situation of a moving body can be managed across different transportation facilities. Therefore, in determination of a fare according to a boarding history described according to a third example embodiment to be described later, when a tie-up campaign between a railroad and an aircraft or the like is planned and a predetermined railroad and a predetermined aircraft are used, processing such as a discount fare application can be performed.

Note that, information recorded in association with the token 80 can be considered other than the example in FIG. 5. For example, information indicating a train or a car which a passenger boards may be associated with the token 80. Further, information indicating a boarding station and an alighting station acquired from the automatic ticket gate 60 to/from which a passenger makes entry and exit may be recorded in association with the token 80.

### Operation Example

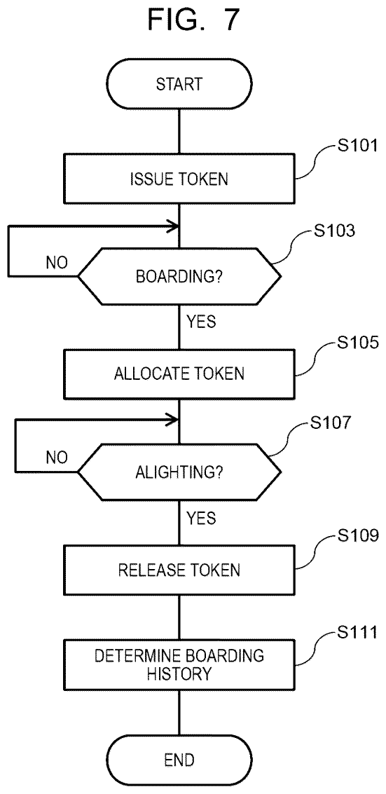

FIG. 7 is a flowchart illustrating an operation example of the information management system 1 according to the present example embodiment.

First, the issuing unit 102 issues at least one token 80 for each moving body (step S101). In an example of a railroad, as illustrated in FIG. 4, a plurality of tokens 80 are issued for each train or for each car. The issuing unit 102 stores, in the storage device 1040, as the issued-token information 202, the plurality of tokens 80 issued for each train or for each car in association with each other.

Then, the allocation unit 104 allocates, when detecting that a passenger boards a moving body (YES in step S103), the token 80 of the moving body to the passenger (step S105).

Specifically, the allocation unit 104 detects boarding when the user U enters the automatic ticket gate 60, and registers the token 80 in the wallet 40 of the user terminal 30 of the user U. Further, the allocation unit 104 acquires identification information (a user ID) of the user U entering the automatic ticket gate 60, and records, in the node 20, the token ID of the token 80, date and time information, and the user ID in association with one another.

Then, the release unit 106 releases, when detecting that the passenger alights from the moving body (Yes in step S107), allocation of the token 80 to the passenger (step S109).

Specifically, the release unit 106 detects alighting when the user U exits from the automatic ticket gate 60, and releases the token 80 registered in the wallet 40 of the user terminal 30 of the user U. Further, the release unit 106 acquires the identification information (the user ID) of the user U exiting from the automatic ticket gate 60, and records, in the node 20, the token ID of the token 80, date and time information, and the user ID in association with one another.

Then, the determination unit 108 determines, by using token history information indicating a history of allocation and release of the token 80, a boarding history for the moving body of the passenger (step S111).

Specifically, the determination unit 108 aggregates records of each token 80 recorded in a plurality of nodes 20 dispersedly, extracts, for example, a record for each user U, and thereby can determine a boarding history for the moving body of the user U.

Further, the determination unit 108 extracts token history information for each train or for each car of a moving body, and thereby, can also determine a situation of the number of passengers of the train or car.

Note that, the flowchart in FIG. 7 includes four pieces of processing, i.e., issuing processing for the token 80 (step S101), on-boarding processing for a passenger (step S103 to step S105), on-alighting processing for a passenger (step S107 to step S109), and boarding history determination processing (step S111). For description, FIG. 7 illustrates four pieces of processing in such a way as to be executed in order, but each piece of processing can be executed independently of each other, and does not necessarily need to be executed in order as in the flowchart in FIG. 7.

As described above, according to the present example embodiment, the issuing unit 102 issues at least one token 80 to a moving body, and the allocation unit 104 allocates, when detecting that a passenger boards the moving body, the token 80 of the moving body to the passenger. Then, the release unit 106 releases, when detecting that the passenger alights from the moving body, the allocation of the token 80 to the passenger, and the determination unit 108 determines a boarding history for the moving body of the passenger, by using token history information indicating a history of allocation and release of the token 80.

In this manner, according to the present example embodiment, the token 80 is allocated to a passenger, the allocation is recorded in the token 80, and thereby a boarding record of the passenger can be efficiently collected and managed.

### Second Example Embodiment

The present example embodiment is similar to the above-described example embodiment except that a configuration that determines a car which a passenger boarded is included. An information management apparatus 100 includes the same configuration as the configuration according to the above-described example embodiment, and therefore description is made by using the function block diagram in FIG. 3.

A determination unit 108 determines, by using token history information of a token 80, a car which a passenger boarded.

As a method of determining a car which a passenger boarded, for example, a general detection technique for a check-in to a predetermined area can be used. The technique is exemplified below without limitation thereto.
(1) By using a short-distance wireless communication function such as Bluetooth (registered trademark) of a user terminal 30 of a passenger, communication with a wireless communication instrument installed in a car is detected.
(2) By using a wireless communication function such as a wireless local area network (LAN) of the user terminal 30 of a passenger, communication with an access point of the wireless LAN installed in a car is detected.
(3) A predetermined sound wave output from a sound wave generator installed in a car is received by a microphone of the user terminal 30 of a passenger.

In the user terminal 30, an application for detecting a check-in to a predetermined area by using a method such as (1) to (3) is installed and started previously. Detection of communication or reception of a sound wave is notified from the application to a server, and thereby the server determines a check-in area of the user terminal 30.

Further, as another example, the following is exemplified.
(4) Biological authentication information (face information, and the like) of a passenger is previously registered, and when the passenger can be determined by collation between biological authentication information of the passenger in a captured image using a camera capturing an image in a car and the registered biological authentication information, it is detected which car (a car where the camera capturing the image is installed is determined) the passenger boarded. Alternatively, by using a captured image of a camera installed in a station yard, a boarding location of a passenger is tracked, and thereby a boarding location is determined.
(5) Location registration information with respect to a base station in a mobile phone communication network of the user terminal 30 is used.
(6) A current location of the user terminal 30 determined by a global positioning system (GPS) reception function of the user terminal 30 is used.

An allocation unit 104 records, in a node 20, when detecting boarding of a user U and allocating the token 80, information indicating a train or a car which the user U boarded in association with a token ID of the token 80, in addition to a boarding date and time and a user ID.

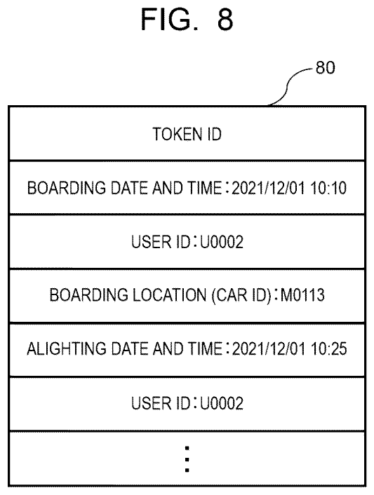

FIG. 8 is a diagram illustrating one example of data structure of the token 80 according to the present example embodiment.

In addition to the information of the token 80 in FIG. 5, further, information indicating a train or a car recorded in association with the token 80 is included. The information indicating a train or a car recorded in association with the token 80 may be identification information (a train ID) identifying a train, or may be identification information (a car ID) identifying a car.

Further, when a user U moves between cars during boarding, the allocation unit 104 may detect a change of a location of the user U, and record information indicating a car of a movement destination every time, together with date and time information.

According to the present example embodiment, the determination unit 108 can determine, by using token history information of the token 80 allocated to a passenger, a car which the passenger boarded.

According to a location of a car, a congestion situation may be different even in the same train, and, for example, a car in a specific location of a train may be congested more than another car. When it is determined which car a user U boarded, a countermeasure for congestion reduction can be effectively taken.

### Third Example Embodiment

FIG. 9 is a function block diagram logically illustrating a configuration of an information management apparatus 100 according to the present example embodiment. The information management apparatus 100 according to the present example embodiment is similar to any of the above-described example embodiments except that a configuration in which settlement processing is performed by using a boarding history of a passenger determined by a determination unit 108 is included.

The information management apparatus 100 in FIG. 9 further includes a settlement processing unit 120, in addition to the configuration of the information management apparatus 100 in FIG. 3.

The settlement processing unit 120 performs, by using a boarding history of a passenger determined by the determination unit 108, settlement processing for a fare of the passenger.

A token 80 is issued for each train and further allocated to a passenger boarding the train, and therefore a boarding passenger can be determined for each train. In other words, a boarding history indicating a train which a passenger boarded can be determined. Then, a boarding situation of a train, for example, a congestion situation can be determined by the number of tokens 80 allocated to passengers.

The settlement processing unit 120 determines, according to a boarding condition of a passenger, a fare of the passenger, and performs settlement processing by using the determined fare.

For example, a fare of a passenger making boarding in a time period, such as a commuting time period, in which the number of passengers is large and congestion occurs is set higher than a fare of a passenger making boarding in a time period other than the former, and thereby it is expected that congestion reduction in a commuting time period and the like is promoted. Therefore, the settlement processing unit 120 modifies, according to a boarding condition of a passenger, a fare of the passenger.

The boarding condition is, for example, at least any one of a time period, a location, a boarding/alighting station, and the like of a train or a car which a passenger boarded. Further, the boarding condition may include a congestion situation of the train or car, or a congestion situation of another train or car which the passenger did not board.

The settlement processing unit 120 determines, according to a congestion situation of a train or a car which a passenger boarded, a fare of the passenger including a discount fare and an extra fare.

The congestion situation can be determined by using token history information, and therefore the settlement processing unit 120 determines, by using the token history information, a fare, for example, as described below.
(1) An extra fare is applied to a train or a car in which the number of tokens 80 allocated to passengers is larger than a reference.
(2) A discount fare is applied to a train or a car in which the number of tokens 80 unallocated to passengers is larger than a reference.

The reference is preferably, for example, the number of tokens 80 for achieving the number of boarding persons of a target set for a train or a car each.

Further, the settlement processing unit 120 may determine a user U fare according to a congestion situation of another train or car during while the user U is on board on a certain train or car.

The boarding history includes, for example, a train or a car which a passenger boarded and a boarding time of the passenger. Further, the boarding condition may include a boarding/alighting station.

The determination unit 108 determines a train or a car which a passenger boarded and a boarding time.

Further, the determination unit 108 may determine a boarding/alighting station of a passenger. In this case, an allocation unit 104 and a release unit 106 record, in a token 80 allocated to a passenger when boarding a moving body, information indicating a section of a train which the passenger boarded, for example, information of a boarding station and an alighting station in association with each other.

The determination unit 108 can determine, by using the boarding history of a passenger determined from the token history information, a train or a car which the passenger boarded and a boarding time of the passenger. Therefore, the determination unit 108 can also determine a train or a car which the passenger did not board and a time period of the event.

The settlement processing unit 120 may determine a fare, for example, as follows, by using the token history information indicating a congestion situation of another train or car while the user U is on board.
(1) When there is a train or a car in which the number of tokens 80 unallocated to passengers is larger than a reference among tokens 80 issued to another train or car (i.e., when another train or another car is more uncrowded), an extra fare is applied to the user U.
(2) When there is a train or a car in which the number of tokens 80 allocated to passengers is larger than a reference among tokens 80 issued to another train or car (i.e., another train or another car is more congested), a discount fare is applied to the user U.

Also, herein, the reference is preferably, for example, the number of tokens 80 for achieving the number of boarding persons of a target set for another train or another car each.

Further, as described above, the information management apparatus 100 can collectively manage pieces of information of different transportation facilities, and therefore the settlement processing unit 120, for example, can determine usage of a predetermined railroad and a predetermined aircraft of a passenger from the token history information, and thereby, perform settlement processing by using a discount fare.

Further, the settlement processing unit 120 may determine a fare of a passenger, by using a boarding time of the passenger.

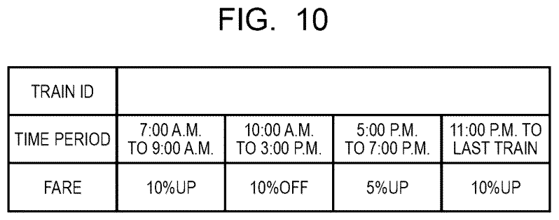

When, for example, a commuting time period and a time period at a last minute of a last train are predicted to be congested, and on the other hand, a daytime time period is predicted to be uncrowded, as illustrated in FIG. 10, a discount rate or an extra rate of a fare may be previously set for each time period. The settlement processing unit 120 can discriminate in what time period a boarding time of a passenger is included, and thereby, determine a fare of the passenger.

### Operation Example

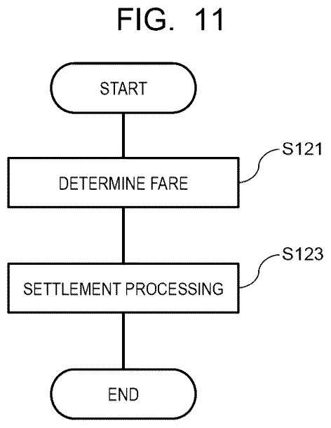

FIG. 11 is a flowchart illustrating an operation example of settlement processing of the information management apparatus 100 according to the present example embodiment.

First, the settlement processing unit 120 determines, by using a boarding history of a passenger determined from token history information, a fare of the passenger according to a boarding condition of the passenger (step S121). When, for example, it is determined that the passenger boarded a train in a commuting time period from the token history information, the settlement processing unit 120 determines that a fare of an extra rate 10% is applied to a normal fare.

Then, the settlement processing unit 120 performs settlement processing for the fare of the passenger, by using the determined fare (step S123).

As described above, according to the present example embodiment, the settlement processing unit 120 determines, by using a boarding history of a passenger determined from token history information, a fare of the passenger according to a boarding condition of the passenger, and performs settlement processing for the passenger by using the determined fare.

Flexible fare setting is made possible by the configuration, based on a boarding situation of a passenger. When, for example, fare setting for each time period is performed, congestion reduction is expected to be promoted.

As described above, with reference to the accompanying drawings, example embodiments of the present invention have been described, but these example embodiments are exemplifications of the present invention, and various configurations other than the above-described configurations are employable.

### <Ex-Post Handling as Commuting Pass or Coupon Ticket>

The determination unit 108 can determine, by using token history information of the token 80, for example, a boarding situation of a train of the user U in a predetermined period. Therefore, when it is determined that a specific section is used beyond a reference number of days or times, for example, for three months, the settlement processing unit 120 may perform settlement processing of computing an amount of difference between a case of applying a fare of a commuting pass or a coupon ticket and a fare already paid by the user, and then issuing a refund, and the like. The amount of difference may be a method other than a refund, but not specifically limited to, a discount of a fare at a next time or later, provision of a point usable for a fare to the user U, and the like.

According to the configuration, a fare of a commuting pass or a coupon thicket can be applied in an ex-post facto manner, which is therefore particularly beneficial to the user U. Further, for a company; there is an advantage in that usage of a moving body can be promoted.

### <Settlement Processing During Substitute Transportation>

When, due to an accident or the like, an operation of a public transportation facility is suspended or a long delay occurs temporarily; another public transportation facility may provide substitute transportation. Currently, in substitute transportation, a boarding ticket for substitute transportation is distributed to a passenger having a commuting pass or the like, and thereby another public transportation facility can be used.

For example, by using token history information of the token 80, the determination unit 108 determines a boarding history of the user U, and thereby, can determine whether the user U uses another public transportation facility based on the substitute transportation. Thereby, the settlement processing unit 120 can perform settlement processing by exempting payment of a fare required for usage of another public transportation facility based on the determined substitute transportation. In other words, without a procedure such as distribution of a boarding ticket for substitute transportation, settlement processing for a fare during substitute transportation can be automatically performed.

Further, even a passenger not to be a target for substitute transportation can contribute to congestion reduction when the passenger uses a detour route. Therefore, usage of a detour route of a passenger is detected, and thereby a discount fare may be applied to the passenger using the detour route. Therefore, the determination unit 108 can determine, by using token history information, usage of a detour route due to an accident or the like.

The determination unit 108 acquires, for example, operation information indicating occurrence of an accident or a long delay: The operation information may be provided, as needed, from a public transportation facility; or may be acquired from a web service providing transportation information. A collection method for operation information is not specifically limited, and the determination unit 108 may periodically collect operation information, or may receive operation information provided from a provider in a push-type manner.

Then, the determination unit 108 determines, for example, a general route in a boarding section of the user U. Then, the determination unit 108 determines whether information of a delay or the like relating to the determined route is included in the acquired operation information. When information of a delay or the like relating to the determined route is included in the acquired operation information and also a route where the user U actually makes boarding and the route are generally different, the determination unit 108 determines that the user U uses a detour route. Then, the settlement processing unit 120 may perform settlement processing by applying a discount fare to a fare relating to the boarding of the user U using the detour route.

According to the configuration, when an operation situation is disturbed due to an accident or the like, a boarding history of the user U can be determined by using token history information of the token 80, and therefore it is determined whether the user U uses substitute transportation, and then settlement processing can be appropriately performed. Alternatively, it can be determined whether a detour route is used, and therefore settlement processing can be performed by applying, as an incentive, a discount fare to the user U using the detour route.

While with reference to the example embodiments and the examples, the invention of the present application has been described, the invention of the present application is not limited to the example embodiments and the examples described above. Configurations and details of the invention of the present application can be subjected to various changes which can be understood by those of ordinary skill in the art without departing from the scope of the invention of the present application.

Note that, when information relating to a user (user U) is acquired and used in the present invention, this shall be done legally.

The whole or part of the example embodiments described above can be described as, but not limited to, the following supplementary notes.

1. An information management apparatus including:
an issuing unit that issues at least one token for each moving body;
an allocation unit that allocates, when detecting that a passenger boards the moving body, the token for the moving body to the passenger;
a release unit that releases, when detecting that the passenger alights from the moving body, allocation of the token to the passenger; and
a determination unit that determines, by using token history information indicating a history of allocation and release of the token, a boarding history for the moving body of the passenger.

2. The information management apparatus according to supplementary note 1, wherein
the moving body is a railroad.

3. The information management apparatus according to supplementary note 1 or 2, wherein
the moving body includes a plurality of cars, and
the issuing unit issues a plurality of tokens for each of the cars.

4. The information management apparatus according to supplementary note 2 or 3, wherein
the determination unit determines, by using the token history information, a car which the passenger boards.

5. The information management apparatus according to any one of supplementary notes 1 to 4, wherein
the token is a non-fungible token (NFT).

6. The information management apparatus according to supplementary note 5, wherein
the determination unit determines, by using the token history information associated with the boarding history in past of the token, a boarding history for the moving body of the passenger.

7. The information management apparatus according to any one of supplementary notes 1 to 6, further including
a settlement processing unit that performs settlement processing for a fare of the passenger, by using the boarding history of the passenger.

8. The information management apparatus according to supplementary note 7, wherein
the settlement processing unit determines a fare of the passenger according to a boarding condition of the passenger, and performs the settlement processing by using the determined fare.

9. The information management apparatus according to supplementary note 8, wherein
the settlement processing unit determines the fare of the passenger, by using a number of unallocated tokens while the passenger is on board.

10. The information management apparatus according to supplementary note 8 or 9, wherein
the moving body includes a plurality of cars, and
the settlement processing unit determines the fare of the passenger, by using a number of unallocated tokens of another car while the passenger is on board.

11. The information management apparatus according to any one of supplementary notes 8 to 10, wherein
the settlement processing unit determines the fare of the passenger, by using a boarding time of the passenger.

12. An information management system including:
the information management apparatus according to any one of supplementary notes 1 to 11; and
a plurality of nodes that store, in a token issued by the information management apparatus, a record of information relating to boarding/alighting of a passenger to/from a moving body.

13. An information management method including,
by an information management apparatus:
issuing at least one token for each moving body;
allocating, when detecting that a passenger boards the moving body, the token for the moving body to the passenger;
releasing, when detecting that the passenger alights from the moving body, allocation of the token to the passenger; and
determining, by using token history information indicating a history of allocation and release of the token, a boarding history for the moving body of the passenger.

14. The information management method according to supplementary note 13, wherein
the moving body is a railroad.

15. The information management method according to supplementary note 13 or 14, wherein
the moving body includes a plurality of cars,
the information management method further including,
by the information management apparatus,
issuing a plurality of tokens for each of the cars.

16. The information management method according to supplementary note 14 or 15, further including,
by the information management apparatus,
determining, by using the token history information, a car which the passenger boards.

17. The information management method according to any one of supplementary notes 13 to 16, wherein
the token is a non-fungible token (NFT).

18. The information management method according to supplementary note 17, further including,
by the information management apparatus,
determining, by using the token history information associated with the boarding history in past of the token, a boarding history for the moving body of the passenger.

19. The information management method according to any one of supplementary notes 13 to 18, further including,
by the information management apparatus,
performing settlement processing for a fare of the passenger, by using the boarding history of the passenger.

20. The information management method according to supplementary note 19, further including,
by the information management apparatus,
determining a fare of the passenger according to a boarding condition of the passenger, and performing the settlement processing by using the determined fare.

21. The information management method according to supplementary note 20, further including,
by the information management apparatus,
determining the fare of the passenger, by using a number of unallocated tokens while the passenger is on board.

22. The information management method according to supplementary note 20 or 21, wherein
the moving body includes a plurality of cars,
the information management method further including,
by the information management apparatus,
determining the fare of the passenger, by using a number of unallocated tokens of another car while the passenger is on board.

23. The information management method according to any one of supplementary notes 20 to 22, further including,
by the information management apparatus,
determining the fare of the passenger, by using a boarding time of the passenger.

24. A program for causing a computer to execute:
a procedure of issuing at least one token for each moving body;
a procedure of allocating, when detecting that a passenger boards the moving body, the token for the moving body to the passenger;
a procedure of releasing, when detecting that the passenger alights from the moving body, allocation of the token to the passenger; and
a procedure of determining, by using token history information indicating a history of allocation and release of the token, a boarding history for the moving body of the passenger.

25 The program according to supplementary note 24, wherein
the moving body is a railroad.

26. The program according to supplementary note 24 or 25, wherein
the moving body includes a plurality of cars,
the program for causing a computer to further execute
a procedure of issuing a plurality of tokens for each of the cars.

27. The program according to supplementary note 25 or 26, for causing a computer to further execute
a procedure of determining, by using the token history information, a car which the passenger boards.

28. The program according to any one of supplementary notes 24 to 27, wherein
the token is a non-fungible token (NFT).

29 The program according to supplementary note 28, for causing a computer to further execute
a procedure of determining, by using the token history information associated with the boarding history in past of the token, a boarding history for the moving body of the passenger.

30. The program according to any one of supplementary notes 24 to 29, for causing a computer to further execute
a procedure of performing settlement processing for a fare of the passenger, by using the boarding history of the passenger.

31. The program according to supplementary note 30, for causing a computer to further execute
a procedure of determining a fare of the passenger according to a boarding condition of the passenger and performing the settlement processing by using the determined fare.

32. The program according to supplementary note 31, for causing a computer to further execute
a procedure of determining the fare of the passenger, by using a number of unallocated tokens while the passenger is on board.

33. The program according to supplementary note 31 or 32, wherein
the moving body includes a plurality of cars,
the program for causing a computer to further execute
a procedure of determining the fare of the passenger, by using a number of unallocated tokens of another car while the passenger is on board.

34. The program according to any one of supplementary notes 24 to 33, for causing a computer to further execute
a procedure of determining the fare of the passenger, by using a boarding time of the passenger.

### REFERENCE SIGNS LIST

1 Information management system
10 Block-chain network
20 Node
20A Usage-waiting token pool
20B Boarding token pool
30 User terminal
40 Wallet
50 Car
60 Automatic ticket gate
80 Token
100 Information management apparatus
102 Issuing unit
104 Allocation unit
106 Release unit
108 Determination unit
120 Settlement processing unit
202 Issued-token information
1000 Computer
1010 Bus
1020 Processor
1030 Memory
1040 Storage device
1050 Input/output interface
1060 Network interface

What is claimed is:

1. An information management apparatus comprising:
at least one memory storing instructions; and
at least one processor configured to execute the instructions to:
issue at least one token for each moving body;
allocate, when detecting that a passenger boards the moving body, the token for the moving body to the passenger;
release, when detecting that the passenger alights from the moving body, allocation of the token to the passenger; and
determine, by using token history information indicating a history of allocation and release of the token, a boarding history for the moving body of the passenger.

2. The information management apparatus according to claim 1, wherein
the moving body is a railroad.

3. The information management apparatus according to claim 1, wherein
the moving body includes a plurality of cars, and
wherein the at least one processor is further configured to execute the instructions to issue a plurality of tokens for each of the cars.

4. The information management apparatus according to claim 2, wherein
the at least one processor is further configured to execute the instructions to determine, by using the token history information, a car which the passenger boards.

5. The information management apparatus according to claim 1, wherein
the token is a non-fungible token (NFT).

6. The information management apparatus according to claim 5, wherein
the at least one processor is further configured to execute the instructions to determine, by using the token history information associated with the boarding history in past of the token, a boarding history for the moving body of the passenger.

7. The information management apparatus according to claim 1, wherein the at least one processor is further configured to execute the instructions to
perform settlement processing for a fare of the passenger, by using the boarding history of the passenger.

8. The information management apparatus according to claim 7, wherein
the at least one processor is further configured to execute the instructions to determine a fare of the passenger according to a boarding condition of the passenger, and perform the settlement processing by using the determined fare.

9. The information management apparatus according to claim 8, wherein
the at least one processor is further configured to execute the instructions to determine the fare of the passenger, by using a number of unallocated tokens while the passenger is on board.

10. The information management apparatus according to claim 8, wherein
the moving body includes a plurality of cars, and
wherein the at least one processor is further configured to execute the instructions to determine the fare of the passenger, by using a number of unallocated tokens of another car while the passenger is on board.

11. The information management apparatus according to claim 8, wherein
the at least one processor is further configured to execute the instructions to determine the fare of the passenger, by using a boarding time of the passenger.

12. An information management system comprising:
the information management apparatus according to claim 1; and
a plurality of nodes that store, in a token issued by the information management apparatus, a record of information relating to boarding/alighting of a passenger to/from a moving body.

13. An information management method comprising,
by an information management apparatus:
issuing at least one token for each moving body;
allocating, when detecting that a passenger boards the moving body, the token for the moving body to the passenger;
releasing, when detecting that the passenger alights from the moving body, allocation of the token to the passenger; and
determining, by using token history information indicating a history of allocation and release of the token, a boarding history for the moving body of the passenger.

14. The information management method according to claim 13, wherein
the moving body is a railroad.

15. The information management method according to claim 13, wherein
the moving body includes a plurality of cars,
the information management method further comprising,
by the information management apparatus,
issuing a plurality of tokens for each of the cars.

16. The information management method according to claim 14, further comprising,
by the information management apparatus,
determining, by using the token history information, a car which the passenger boards.

17. The information management method according to claim 13, wherein
the token is a non-fungible token (NFT).

18. (canceled)

19. The information management method according to claim 13, further comprising,
by the information management apparatus,
performing settlement processing for a fare of the passenger, by using the boarding history of the passenger.

20. The information management method according to claim 19, further comprising,
by the information management apparatus,
determining a fare of the passenger according to a boarding condition of the passenger, and performing the settlement processing by using the determined fare.

21-23. (canceled)

24. A non-transitory computer-readable storage medium storing a program for causing a computer to execute:
a procedure of issuing at least one token for each moving body;
a procedure of allocating, when detecting that a passenger boards the moving body, the token for the moving body to the passenger;
a procedure of releasing, when detecting that the passenger alights from the moving body, allocation of the token to the passenger; and
a procedure of determining, by using token history information indicating a history of allocation and release of the token, a boarding history for the moving body of the passenger.

25-34. (canceled)
